(19) United States
(12) Patent Application Publication
(10) Pub. No.: US 2010/0030805 A1
(43) Pub. Date: Feb. 4, 2010

(54) PROPAGATING INFORMATION FROM A TRUST CHAIN PROCESSING

(75) Inventors: Heather Maria Hinton, Austin, TX (US); Sridhar R. Muppidi, Austin, TX (US); David Eugene Cox, Raleigh, NC (US)

Correspondence Address: IBM Corp. (GIG), c/o Garg Law Firm, PLLC, 4521 Copper Mountain Lane, Richardson, TX, 75082, US

(73) Assignee: International Business Machines Corporation, Armonk, NY (US)

(21) Appl. No.: 12/182,654

(22) Filed: Jul. 30, 2008

(51) Int. Cl. G06F 17/30; H04L 9/32

(52) U.S. Cl. 707/104.1; 726/3; 726/9; 707/E17.008; 707/E17.01

(57) ABSTRACT

A method, system, and computer usable program product for propagating information in a trust chain processing are provided in the illustrative embodiments. Upon a trust client invoking the trust chain processing, a mapped security information is received, the mapped security information being stored in a memory or a data storage associated with a data processing system. A set of security information attributes are located from the mapped security information according to a configuration. The set of security information attributes are packaged to form a packaged security information. The packaged security information is issued to a target system, the target system being distinct from the trust client that invoked the trust chain processing. The locating, the packaging, and the issuing collectively form monitoring the trust chain processing. A next component in the trust chain processing may be invoked. The invoking may occur before, after, or during the monitoring.

### BACKGROUND OF THE INVENTION

1. Field of the Invention

The present invention relates generally to an improved data processing system, and in particular, to a computer implemented method for processing requests for information in a data processing system. Still more particularly, the present invention relates to a computer implemented method, system, and computer usable program code for propagating information from a trust chain processing.

2. Description of the Related Art

Data processing systems and applications executing thereon interact with each other in a data processing environment. Often, such interactions have to pass some type of security system so that only authorized data processing systems and applications are permitted to interact with each other in the data processing environment.

A variety of security systems is available for use in data processing environments. Some security systems verify the identity of a data processing system, an application, or a user, such as by using digital signatures. Other security systems verify the identity as well as authorization of a data processing system, an application, or a user to engage in the interaction in question. For example, a security system may use a combination of digital signature, encryption keys, and access control parameters to perform this level of security enforcement.

Still other security systems employ a structured method of presenting and processing security related information. This information may be contained within a message. The message may be consistent with standard-based descriptions, such as those provided by web services specifications, for example, WS-Security and WS-Trust specifications. For example, WS-Security specification describes how to include a pre-defined part of a message, such as a security header dedicated to carrying security information, into the message. As another example, WS-Trust specification defines how to structure information within the security header defined by the WS-Security specification.

Processing of security information included within a message according to these standards based definitions requires several steps and may be completed through functionality provided by a “trust server.” A Trust Server processes this security information through a process known as trust chain processing.

One such structured method of presenting this security information is a security token format defined by the Security Assertion Markup Language (SAML). A security token is an organization of security information in a predefined format. The security information presented in a SAML-defined security token is called a SAML token. A SAML token is also known as a SAML assertion. The processing of the security information presented in this manner is called SAML token processing. Processing of security information represented by a SAML token often requires more than one step and may be completed by a trust server. SAML is an extensible markup language (XML) based organization of authentication and authorization information exchanged between, and within, security domains.

A security domain is a data processing environment, bound by a trust relationship, within which a given security token may be used. Information passed across security domains requires additional trust relationships to ensure that information valid in one domain can be trusted in another domain. A security domain may pass security tokens, such as SAML token, within a security domain or to another security domain when a data processing system, an application, or a user in the first security domain requests to access data, functionality, or services provided by the other security domain. Security domains include the security infrastructure capable of performing security token processing and assessing the authentication and authorization parameters of the requesting data processing system, application, or user.

### SUMMARY OF THE INVENTION

The illustrative embodiments provide a method, system, and computer usable program product for propagating information in a trust chain processing. Upon a trust client invoking the trust chain processing, mapped security information is received, the mapped security information being stored in a memory or a data storage associated with a data processing system. A set of security information attributes are located from the mapped security information according to a configuration. The set of security information attributes are packaged to form packaged security information. The packaged security information is issued to a target system, the target system being distinct from the trust client that invoked the trust chain processing. The locating, the packaging, and the issuing collectively form monitoring the trust chain processing. A next component in the trust chain processing may be invoked. The invoking may occur before the monitoring, after the monitoring, or during the monitoring.

The configuration may identify the set of security information attributes, the target system, and a method of communication with the target system. The configuration may be identified in a trust chain configuration. The configuration may be loaded as a part of a dynamic configuration of the trust chain processing. Loading the configuration may make the configuration available for monitoring the trust chain processing.

The configuration may be stored in a configuration file, coded in a code, provided in a parameter list, or specified in an input. The configuration may identify several target systems and several methods of communication to communicate with the several target systems.

The configuration may identify an organization of information in a monitoring log. The monitoring log may be accessible to several target systems. A target system may use a subset of the information in the monitoring log.

In one embodiment, the packaged security information may be a JAAS subject. In another embodiment, the security information may be a SAML token, and the set of security information attributes may be a set of SAML token attributes.

The packaged security information may include attributes that have been derived from received security information. The issuing in the monitoring and a second issuing to the trust client to the monitoring system and the trust chain processing may occur simultaneously.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts logical representation of the trust chain processing relative to an application that receives and depends on the security token and its information;

FIG. 4 depicts a block diagram of a trust chain processing system within which the illustrative embodiments may be implemented;

FIG. 5 depicts a block diagram of a data processing environment in which the illustrative embodiments may be implemented;

FIG. 6 depicts a trust chain processing system in accordance with an illustrative embodiment;

FIG. 7 depicts a flowchart of a process of processing security information in a trust chain processing system in accordance with an illustrative embodiment; and

FIG. 8 depicts a flowchart of monitoring security information in accordance with an illustrative embodiment.

### DETAILED DESCRIPTION OF THE PREFERRED EMBODIMENT

Many applications have to use some or all of the security information that may be included in a SAML token or some equivalent thereof. However, illustrative embodiments recognize that few applications have the capability of understanding security information that may be organized in any of a number of ways of organizing security information. Trust chain processing, for example, SAML token processing, may not be within the capabilities of many applications that have to use the security information typically presented in SAML Tokens.

Presently, a security system capable of processing the type of organization of security information expected in a data processing environment is included as a layer on top of many applications. Such a security system forming such a layer in a data processing environment is also known as a federated identity management system. As an example, a federated identity management system responsible for trust chain processing in a security domain may process a SAML token that a different security domain may present with a request to a particular application within the security domain of the federated identity management system. The federated identity management system then transforms the security information from the SAML token into a form that the particular application may know how to use, and passes the transformed security information to that application.

Illustrative embodiments recognize that the processing of security information in this manner may cause some of the security information to be lost in the transformation. For example, the security information may be transformed so that it usable to a first application but may be no longer be in a form that is usable to a second downstream application and thus may be lost for down-stream processing. Illustrative embodiments further recognize that presently, if such a loss is not desirable in a security domain, the federated identity management system in the security domain presently handles the security information using one of two following methods.

In the first method, the federated identity management system may process and optionally transform the security information, such as a SAML token while also retaining the SAML token for downstream processing. The federated identity management system may pass the SAML token to a downstream target system. Thus, the target system must be able to process the SAML token again to retrieve the security information that may otherwise be lost. Illustrative embodiments recognize that trust chain processing, such as a SAML token processing, consumes significant computing resources in a data processing environment and may require modifications to downstream applications to enable them to invoke the required trust chain processing to retrieve required information from the received SAML token. Thus, employing this method may result in inefficiencies in the data processing environment and performance degradation of the target system.

In the second method the federated identity management system transforms all of the security information in all possible forms usable by a particular target system. A target system, or target, is a data processing system or an application to which the request accompanying the security information is directed. Illustrative embodiments recognize that processing security information in this manner is target specific and consequently labor intensive and error prone. For example, a format usable with one target system may not be usable with another. Maintaining a number of transformations for a number of targets may be cumbersome and prone to errors.

Presently, there are no standard means of communicating information from tokens down-stream as many down-stream applications are rigid in the form in which they expect to receive this information and rigid in the information that they expect to receive. For example, they may well expect only one attribute, a username or JAAS subject, but may actually depend on many attributes, such as subject, age, location, and other attributes. Such additional attributes, however, cannot be passed because the down-stream system may not know how to receive or retrieve this information when presented as part of the communication flow. Additionally, attributes that are propagated outside of the trust chain may be attributes that are not included in the received SAML token but may be determined based on configuration or processing of the individual trust chain modules. Thus, these attributes may not be security related in any way other than the fact that they were found based on the identity asserted in the security information.

To address these and other problems related to processing security information, the illustrative embodiments provide a method, system, and computer usable program product for propagating information from a trust chain processing. The illustrative embodiments may be used in conjunction with any application or any data processing system that may use security information, including but not limited to presently available federated identity management systems. The illustrative embodiments are described using SAML token processing only as an example, and the described SAML tokens or processing thereof is not limiting on the illustrative embodiments. The illustrative embodiments may be used in conjunction with any organization of security information and in any type of trust chain processing. In some implementations, the illustrative embodiments may be used to process information related to a particular sender of a request, or information related to a request, transaction, or processing in the manner described to gain access to controlled resources.

For example, the illustrative embodiments may be implemented with a digital certificate processing system. The illustrative embodiments may further be implemented in conjunction with any business application, enterprise software, and middleware applications or platforms. Additionally, the illustrative embodiments may be implemented in conjunction with a hardware component, such as in a firmware, as embedded software in a hardware device, or in any other suitable hardware or software form.

The illustrative embodiments provide a method, system, and computer usable program product for propagating information from a token processing system for use by other systems. A token processing system may include pluggable modules that together implement a set of token processing steps used to complete a token processing task. Such a token processing system may be used where the token is a security token or any other token containing information that has to be processed using token processing.

A trust chain processing system including a token processing system may be used to process certain information contained in a message or required for processing a message. This information can be a part of the message or be a security token, such as a SAML token, that is bound to the message. For example, the information may be in a format of a token that the token processing system may validate, map, or issue for use in relation with the message. The token processing system according to the illustrative embodiments may also communicate the results of such processing to other systems.

When the information to be processed is represented as a security token, namely a token containing security specific or other information, the trust chain processing system according to the illustrative embodiments may take the form of a security token service. When acting as a security token service, the processing of an illustrative embodiment may be invoked when a message with security information is received or when a message containing security information is to be generated.

When a message with security information is received, the illustrative embodiments extract the security information from the message, typically from a security header, and pass the security information to the trust chain processing system of the illustrative embodiments for processing. The trust chain processing system of the illustrative embodiments receive the security as a complex security information that may be encrypted and signed and may take many different formats. Complex security information is security information including multiple values.

The security information processed by the illustrative embodiments may have to be mapped, or converted, to a different form. In some cases, the security information may already be in a converted form at processing, and the illustrative embodiments may re-map the security information. The mapped or to-be-mapped security information may be stored in either a memory or a data storage associated with a data processing system or both.

Any advantages listed herein are only exemplary and are not intended to be limiting on the illustrative embodiments. Additional advantages may be realized by specific illustrative embodiments. Furthermore, a particular illustrative embodiment may have some, all, or none of the advantages listed above.

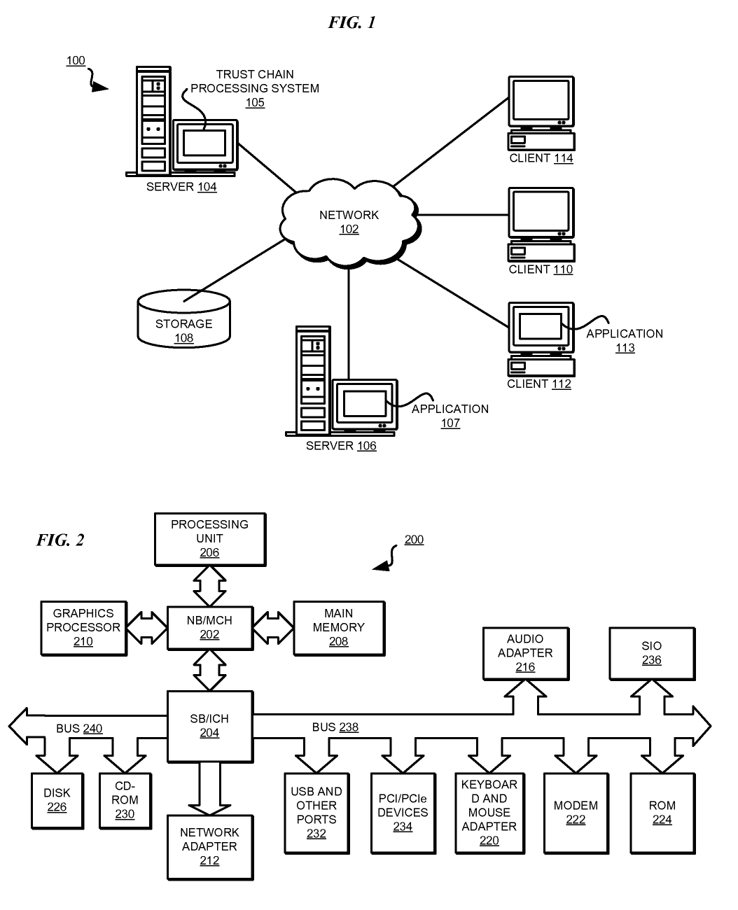

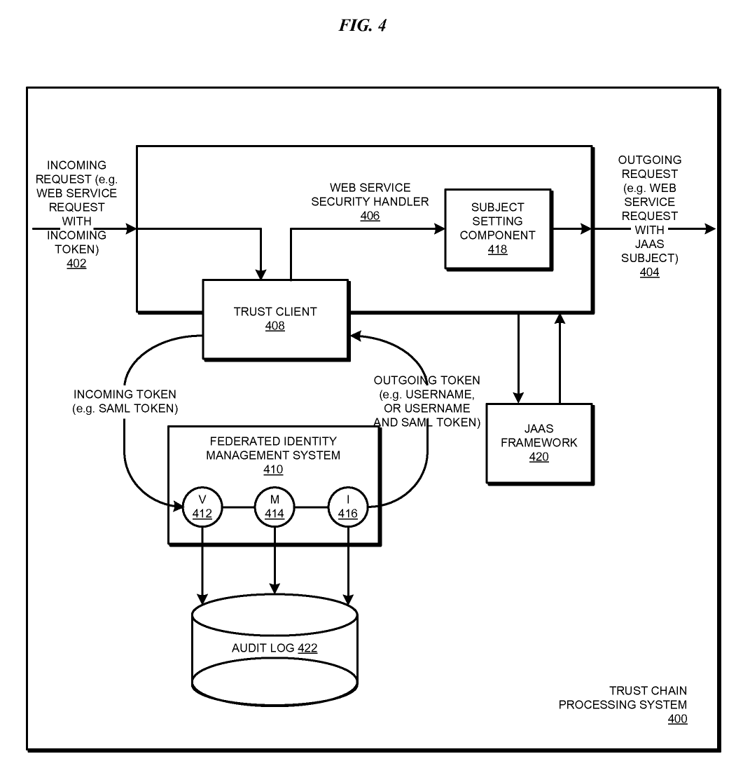

With reference to the figures and in particular with reference to FIGS. 1 and 2, these figures are exemplary diagrams of data processing environments in which illustrative embodiments may be implemented. FIGS. 1 and 2 are only exemplary and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108.

Software applications may execute on any computer in data processing environment 100. In the depicted example, server 104 includes trust chain processing system 105, which may be an exemplary software application, in conjunction with which the illustrative embodiments may be implemented. Server 106 may include application 107, which may be a target system. Client 112 may be in a different security domain than the security domain of servers 104 and 106. Client 112 may include application 113, which may present a SAML token.

In addition, clients 110, 112, and 114 couple to network 102. Any of clients 110, 112, and 114 may have an application, typically a client application, executing thereon. As an example, client 112 is depicted to have browser 113 executing thereon. Browser 113 may be a commonly used web-browser.

Servers 104 and 106, storage units 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 provides data, such as boot files, operating system images, and applications to clients 110, 112, and 114. Clients 110, 112, and 114 are clients to server 104 in this example. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® XP (Microsoft and Windows are trademarks of Microsoft Corporation in the United States and other countries), or Linux® (Linux is the trademark of Linus Torvalds in the United States and other countries). An object oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

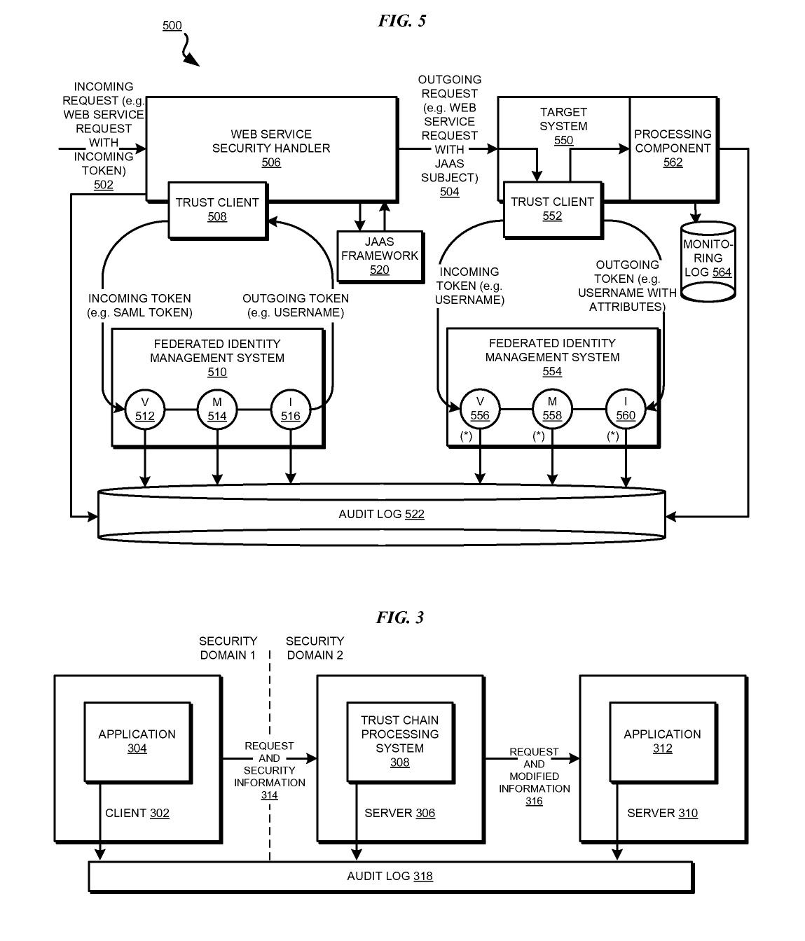

With reference to FIG. 3, this figure depicts a block diagram of a trust chain processing system in which the illustrative embodiments may be implemented. Client 302 and application 304 may be implemented using client 112 and application 113 in FIG. 1 respectively. Server 306 and trust chain processing system 308 may be implemented using server 104 and trust chain processing system 105 in FIG. 1 respectively. Server 310 and application 312 may be implemented using server 106 and application 107 in FIG. 1 respectively.

As an example, client 302 is depicted as belonging to security domain 1, which is different from security domain 2 where servers 306 and 310 are located. In some cases, client 302 and server 306 and 310 may be located in the same security domain. The illustrative embodiments are equally applicable to such cases of propagating information within a security domain as well. Application 304 may send request and security information 314 to application 312. Security information portion in request and security information 314 may be a SAML token.

Trust chain processing system 308 may transform the security information in request 314 such that application 312 receives request and modified information 316. In one embodiment, the request and security information in request 314 and request portion and information 316 may remain unaltered through trust chain processing system 308. In another embodiment, trust chain processing system 308 may modify the request portion as well as the security information from request and security information 314 and request portion and modified information 316. Modified information 316 may be security-related or non-security-related information.

In general, trust chain processing does not change or modify the request, where the request is anything other than the security header/token. In an implementation, the request, such as for transferring funds from account A to account B, may not be altered by the trust chain processing. The token information, on the other hand, may be altered, where the incoming token may be in a form other than a SAML token, such as a X.509 certificate, that is exchanged for a SAML assertion with attributes, such as username, account number, and bank branch code. As a result, the message forwarded after trust chain processing has the untouched request with a SAML assertion replacing the X.509 certificate.

Application 304, trust chain processing system 308, and application 308 may each emit log entries for a common audit log or separate audit logs. As an example, application 304, trust chain processing system 308, and application 312 are depicted as writing audit log entries to audit log 318.

At trust chain processing system 308, information about the message in which this security information was received is used to determine a configuration to load. This configuration identifies how to process the received security information, including the steps required by the trust chain processing system. Each of these steps may be implemented by an individual security information module according to configuration. This set of security information modules, when executed in series, provides a chain of processing that implements the overall processing for the received security information.

Additional configuration information may be used to add additional security modules to the trust chain processing according to the illustrative embodiments. These modules may be common for all configurations, such as being a part of the overall trust chain processing configuration's metadata, or part of the overall trust chain. The modules according to the illustrative embodiments may also be specific to the information and message source or destination, thus being local to an instance of a trust chain configuration. These additional modules, whether globally applied to all trust chains, or locally applied to specific trust chains, may be used for communicating subsets of the security information, and metadata about its processing, to systems outside of the trust chain processing system. Furthermore, such communications may be independent of the system that requested the trust chain processing.

The configuration may identify a set of security information modules, a set of configuration information used by each of the security information modules, and information about additional or external target systems to receive a subset of the security information, metadata about the information processing. The configuration may also include a set of configuration information defining how to format this information so that it can be presented to this external target system. The configuration may be stored in a configuration file, coded in a code, provided in a parameter list, or specified in an input.

With reference to FIG. 4, this figure depicts a block diagram of a trust chain processing system within which the illustrative embodiments may be implemented. Trust chain processing system 400 may be implemented as trust chain processing system 308 in FIG. 3. Incoming request 402 may be a web service request with an incoming token, such as a SAML token. Incoming request 402 may be analogous to request and security information 314 in FIG. 3. Trust chain processing system 400 is depicted as processing a SAML token only as an example. Trust chain processing system 400 may be a trust chain processing system for processing any type of tokenized information, whether or not related to security.

Outgoing request 404 may be a web service request according to incoming request 402, but modified such that outgoing request 404 is a web service request with the incoming token and/or modified security information, such as Java Authentication and Authorization Service (JAAS) subject. To authorize access to resources, applications first need to authenticate the source of the request. The JAAS framework defines the term “subject” to represent the source of a request. A subject may be any entity, such as a person or a service. Once the subject is authenticated, a Java security object called “subject” is populated with identities associated with the request. The identities are called principals and a subject may have several principals. For example, a user associated with the request may have a name principal, e.g., “John Doe”, and a social security number principal, e.g. 123-45-6789.

A subject may also include security information in the form of security related attributes called credentials or other general use attributes. For example, the subject may include other attributes that may not be security attributes. The subject may include such attributes for use by down-stream systems within a security domain so that those down-stream systems do not have to regenerate, calculate, or find those attributes.

A subject may include certain credential sets, such as private cryptographic keys, with special protection as private credential sets. A credential set is one or more credentials. Similarly, credential sets intended to be shared, such as public key certificates, are stored as public credential sets. An application may have to have different permissions to access and modify the different credential sets.

The operation of trust chain processing system 400 is described using a SAML token as an example of the incoming token in incoming request 402. Web service security handler 406 may be a component that communicates with data processing systems, applications, and users. Some of these data processing systems, applications, and users may send requests with security information and some may be target systems.

Web service security handler 406 may route incoming request 402 to trust client 408. Trust client 408 may be a component that facilitates communication between web service security handler 406 and federated identity management system 410. Federated identity management system 410 is also known as a trust service. Trust client 408 may pass the security information associated with incoming request 402, such as a SAML token, to federated identity management system 410, and may also send a copy of the incoming request 402 in “read-only” format.

Federated identity management system 410 may include validating component 412 that may validate the security information. Federated identity management system 410 may further include one or more mapping component 414 that may map or manipulate the security information into a modified format suitable for a target system. Issuing component 416 may issue or publish the modified security information as an outgoing token so that other components may send the outgoing token to the target system. A particular sequence of one or more validating component 412, one or more mapping component 414, and issuing component 416 is called a trust chain.

An outgoing token may include only the security information that a target system may be able to use. For example, the outgoing token may discard everything in the SAML token accompanying incoming request 402 and include only an identity associated with the original requester of incoming request 402. A particular implementation may include more, less, or different information in the outgoing token.

Federated identity management system 410 returns the processed information to trust client 408 in the form of an outgoing token. Trust client 408 passes the outgoing token back to web service security handler 406, which may then replace the security token in incoming request 402 with the information received from the trust service 410. Web service security handler 406 may include subject setting component 418. Subject setting component 418 may use the outgoing token to set the subject object in outgoing request 404. Subject setting component 418 may set the subject in collaboration with JAAS framework 420 provided by a Java Virtual Machine. Web service security handler 406 may then send outgoing request 404 to a target system for responding.

While performing each of their respective functions, validating component 412, mapping component 414, and issuing component 416 may write some or all of the information contained in the security token, such as a SAML token, to audit log 422. For example, validating component 412 may write the received SAML token to audit log 422. Mapping component may 414 may write the received SAML token and mapped information to audit log 422. Issuing component 416 may write the mapped and issued information to audit log 422.

Audit log 422 may be a flat file, an index file, a relational database, an object oriented database, or a data structure of any other type suitable for storing data. Audit log 422 may provide the information written by the components of federated identity management system 410 to other applications, such as reporting applications. Some examples of the reporting applications may include a composite application management application and a forensics and identity governance application. A target application, however, has to know how to access audit log 422 and have sufficient privileges to access audit log 422. Furthermore, a target system has to have information about the schema of audit log 422 to read the information stored therein. A schema is information about the organization of data.

Additionally, trust client 408 and federated identity management system 410 processes the information received. Each component emits a potentially different audit record to audit log 422. Consequently, there is an overall cost associated with processing by federated identity management system 410, as validation by validating component 412 and issue by issuing component 416 are always performed. The cost associated with this processing is a minimum of the cost of processing the information through the trust service—federated identity management system 410, and the trust chain—validating component 412, issuing component 416, and mapping component 414. Mapping component 414's cost is an additional processing cost. Thus, if additional mapping is performed down-stream, the processing cost is not just the cost of the mapping, but the inherent cost of the trust service, the trust chain, and the mapping cost all over again. Illustrative embodiments provide a way in which such information can be made available to target systems in a more efficient manner in comparison.

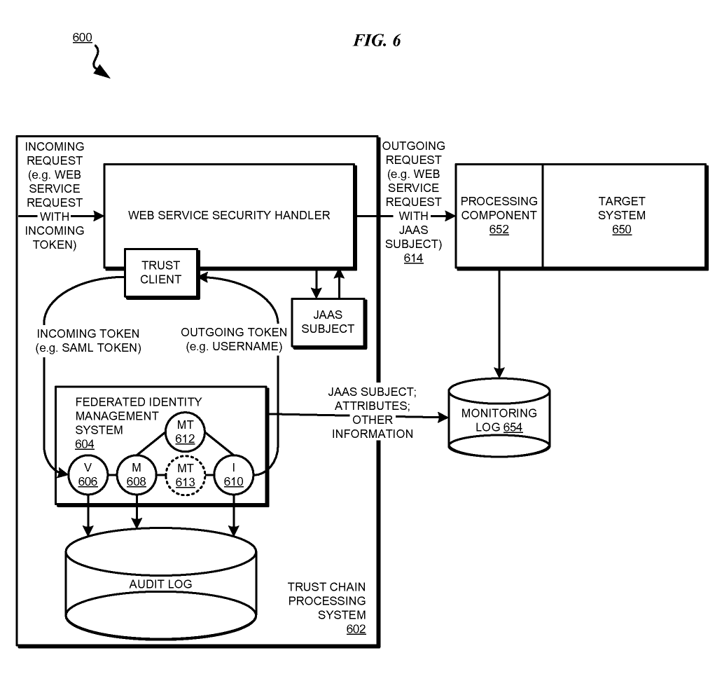

With reference to FIG. 5, this figure depicts a block diagram of a data processing environment in which the illustrative embodiments may be implemented. Data processing environment 500 may include a trust chain processing system that is enabled for SAML token processing. Data processing system 500 further includes a target system that receives security information that is derived from the SAML token from the trust chain processing system.

Incoming request 502 may be similar to incoming request 402 in FIG. 4. Outgoing request 504 may be similar to outgoing request 404 in FIG. 4. Web service security handler 506 may be similar to web service security handler 406 in FIG. 4. Trust client 508 may be similar to trust client 408 in FIG. 4. Federated identity management system 510, validating component 512, mapping component 514, and issuing component 516 may be similar to federated identity management system 410, validating component 412, mapping component 414, and issuing component 416 respectively in FIG. 4. JAAS framework 520 may be similar to JAAS framework 420 in FIG. 4. Audit log 522 may be similar to audit log 422 in FIG. 4.

Target system 550 receives outgoing request 504, which may include a JAAS subject as described with respect to FIG. 4. In one embodiment, outgoing request 504 may include a token, which may be an outgoing token or a copy of the incoming token, in addition to the JAAS subject.

Target system 550 may process the JAAS subject and any accompanying token in a manner similar to the processing in trust chain processing system 400 in FIG. 4. For example, if outgoing request 504 only includes a JAAS subject, target system 550 may pass the JAAS subject to trust client 552. Trust client 552 may pass the JAAS subject to federated identity management system 554. Federated identity management system 554 includes validating component 556 and issuing component 560. Federated identity management system 554 may include one or more mapping component 558. Federated identity management system 554 may process the security information contained in the JAAS subject in a manner similar to the corresponding components in FIG. 4. As described with respect to FIG. 4, JAAS subject may include some portions of the security information of the incoming SAML token, also called SAML token attributes.

Federated identity management system 554, including validating component 556, mapping component 558, and issuing component 560, may process the JAAS subject, extract the SAML token attributes from the JAAS subject, and write them to audit log 522. As part of this processing, mapping component 558 may map the received JAAS subject to a locally valid JAAS subject valid in the context of receiving application 550 or retrieve additional attributes required for local processing. In one implementation, audit log 522 may be common to federated identity management system 510 and federated identity management system 554.

Federated identity management system 554 associated with target system 550 may issue a second outgoing token that may include the security information used in target system 550. For example, the second outgoing token may include a username and some of the SAML attributes that target system 550 knows how to use.

Presently, it may not be convenient for an application to trace through a set of audit log records to determine what identity is associated with a particular request as the identity information passes through multiple applications for processing and request completion. The illustrative embodiments recognize that presently, due to the absence of other more convenient alternatives, applications must trace through audit log to get this information into a monitoring log of a composite application manager or another monitoring application.

The illustrative embodiments described herein may be implemented to enable a comparatively more convenient tracing through the audit logs for such information. The illustrative embodiments use the monitoring module as described herein to send the information to the monitoring application. By using the illustrative embodiments, the composite application manager or another monitoring application does not have to understand the audit logs and comb through them.

The second outgoing token is passed back to trust client 552, which may pass the second outgoing token to processing component 562. Processing component 562 processes the outgoing request based on the second outgoing token, which includes some of the SAML token attributes.

As an example, processing component 562 may be a part of an application monitoring solution. Processing component 562 may create entries related to processing the outgoing request in a specialized type of audit log, monitoring log 564. Unlike an audit log, all information stored in monitoring log 564 has the same schema. Monitoring log 564 may include information that an application may use to monitor, and report on the transactions that target system 550 may be processing.

Illustrative embodiments recognize that a system as depicted in FIG. 5 may place a burden on target system 550 such that the performance of target system 550 may degrade. Notice that target system 550 may have to process at least some attributes of SAML token again in order to produce a response to outgoing request 504 and entries in monitoring log 564, assuming that the SAML token is available as part of incoming request 504. If the SAML token is no longer available, then target system 550 may have to regenerate the information contained in the token through other means within the trust chain processing in order to make this information available to processing component 562 and thus to monitoring log 564.

Thus, presently, a composite application manager or another monitoring application may provide a user a status of a transaction or set of transactions related to the user. Therefore, extracting this information from the audit log, or feeding it directly into the monitoring log from a specialized trust module, as in the illustrative embodiments will be beneficial.

Illustrative embodiments recognize that presently, federated identity management system 510, validating component 512, issuing component 516, and mapping component 514 are not the only entities that emit audit records to the audit log. The additional mapping performed by mapping component 558 requires processing cost of federated identity management system 554, validating component 556, issuing component 560, mapping component 558, and the writing of the audit logs there from, in order to provide the information necessary as part of generating the information written to monitoring log 564.

With reference to FIG. 6, this figure depicts a trust chain processing system in accordance with an illustrative embodiment. Data processing environment 600 maybe similar to data processing environment 500 in FIG. 5. Trust chain processing system 602 may be implemented using trust chain processing system 400 in FIG. 4.

Trust chain processing system 602 includes federated identity management system 604, which includes validating component 606, mapping component 608, and issuing component 610, similar to the corresponding components depicted in FIGS. 4 and 5. Federated identity management system 604 further includes monitoring component 612 in accordance with an illustrative embodiment.

Monitoring component 612 monitors the transaction associated with outgoing request 614 and the identifier associated with this request. In one embodiment, monitoring component 612 receives the mapped security information components from mapping component 608 without disrupting the flow of such information from mapping component 608 to issuing component 610. In such an embodiment, monitoring component 612 may occupy a pass-through position in the form of monitoring component 613. For example, mapping component 608 may map the SAML token attributes. Mapping security information is parsing the security information into security information components, separating those security information components, and translating or transforming some or all of those security information components into a usable form. For example, mapping an SAML token may include parsing the incoming SAML token, separating the SAML token attributes, and translating or transforming some of the SAML token attributes.

Once the mapped security information is available in mapping component 608, monitoring component 612 may request such information from mapping component 608, or mapping component 608 may send such information to monitoring component 612 without a request. Mapping component 608, during the mapping process may have already identified the security information components that may be included in a JAAS subject associated with outgoing request 614. Thus, monitoring component 612 may receive not only the security information components from mapping component 608, but also information about which of those security information components may belong in a JAAS subject.

Monitoring component 612 may use configuration information to determine which of the security information or other attributes are useful to target system 650 or monitoring log 654. Based on such configuration, monitoring component 412 may gather those attributes and issue them to monitoring log 654. Monitoring log 654 may use the attributes, for example, to report status on threads related to a user or customer, or to report a service level. In one embodiment, the configuration information used by monitoring component 612 may be a configuration file in the form of a flat file, a database entry, or any other suitable form. In another embodiment, the configuration information may be hard-coded within monitoring component 612. For example, the configuration information may be a set of values provided in the code for monitoring component 612.

In another embodiment, monitoring component 612 may receive the configuration information from target system 650 or another application. For example, target system 650 or an administration application may provide the configuration information as a list of parameters in calling a function built into monitoring component 612. In another embodiment, a user interface, such as a graphical user interface, may be used for providing the configuration information to monitoring component 612.

In another embodiment, monitoring component 612 may use configuration information to determine which of the security information components are useful to monitoring log 654. Configuring monitoring component 612 based on monitoring log 654 may be useful when multiple target system 650 may reference monitoring log 654 and use a subset of the information contained in monitoring log 654.

These methods of providing the configuration information to monitoring component 612 are described only as exemplary and are not limiting on the illustrative embodiments. Many other methods of configuring monitoring component 612 for accomplishing the functions of monitoring component 612 will be apparent from this disclosure and the same are contemplated within the scope of the illustrative embodiments.

In one embodiment, as in FIG. 5, target system 650 may include processing component 652. Processing component 652 may create entries in monitoring log 654. Such entries may include some security information components that may have been included in the security information associated with the incoming request, such as an incoming SAML token. Monitoring component 612 may be configured as described above to monitor such security information components as they are mapped by mapping component 608. For example, a configuration file for monitoring component 612 may specify certain SAML token attributes to monitor for use by target system 650.

When such security information attributes are available from mapping component 610, monitoring component 612 may receive them and send to monitoring log 654. For example, when certain SAML token attributes have been mapped from an incoming SAML token, monitoring component 612 may receive those SAML token attributes and pass them to monitoring log 654.

In addition, in one embodiment, monitoring component 612 may pass JAAS subject information associated with the outgoing request together with information required by the user of the monitoring log, such as information that will allow an application's status, response time and transaction throughput to be determined for the subject associated with the out going request. The JAAS subject information may include the security information components that may be included in a JAAS subject. For example, a JAAS subject may include some SAML token attributes, and monitoring component 612 may pass such SAML token attributes. Monitoring component 612 may pass such security information components to monitoring log 654, or target system 650, or a component of target system 650, such as processing component 652. Monitoring component 612 may be able to pass the security information components that are relevant to a JAAS subject because mapping component 610 may have already identified the security information components that are to be used in the construction of the JAAS subject during the mapping process.

Furthermore, monitoring component 612 may be configured to pass additional information to monitoring log 654, or target system 650, or a component of target system 650. Such additional information may be in addition to the security information attributes and security information relevant to a JAAS subject. The nature and contents of such additional information may be implementation dependent. For example, in one embodiment, monitoring component 612 may pass a unique identifier associated with the incoming request as additional information. In another embodiment, the combination of the security information attributes, JAAS subject information, and additional information provided by monitoring component 612 may allow a user of monitoring log 654 to sort monitoring log entries by transactions, senders of requests, and many other parameters. As an example in action, an attribute may represent a preferred membership number with a car rental company. Such an attribute may indicate that many subjects may be mapped to this single attribute, but that monitoring reporting may be done at the granularity of response time/transaction throughput for all users. The report may permit reviewing activities of a particular user (identified by JAAS subject) within the group of preferred members.

In another embodiment, monitoring component 612 may send the various pieces of information to a different destination, such as to a compliance application, a sales log, marketing database, troubleshooting list, a quality control log, or a report generation tool. An embodiment may allow monitoring component 612 to be turned on or turned off. For example, monitoring component 612 may be turned on when security information, such as a SAML token, is associated with a request, and turned off otherwise.

A trust chain is usually built dynamically at runtime based on the incoming request and the associated requested application. The configuration of the trust chain may include specific mapping component 608 to use for constructing a specific trust chain. Furthermore, according to the illustrative embodiments, the configuration of the trust chain can be extended to include a specific monitoring component, such as monitoring component 612 or 613, where there are multiple monitoring components each with their own configuration information.

As another example, monitoring component 612 may be turned on when the marketing department has to compile a list of transactions from certain senders for up-selling or cross-selling purposes. As another example, an administrator may be able to display a list of monitored transactions by user using the functions of monitoring component 612. The administrator may use the list to monitor throughput, response time, and other metrics for transactions associated with the user. The administrator may also be able to perform similar monitoring for a set of users where the set of users may be grouped based on a common attribute, either carried with the SAML token or mapped based on the SAML token. Many other situations where controlling monitoring component 612 in this manner may be useful will be conceivable from this disclosure.

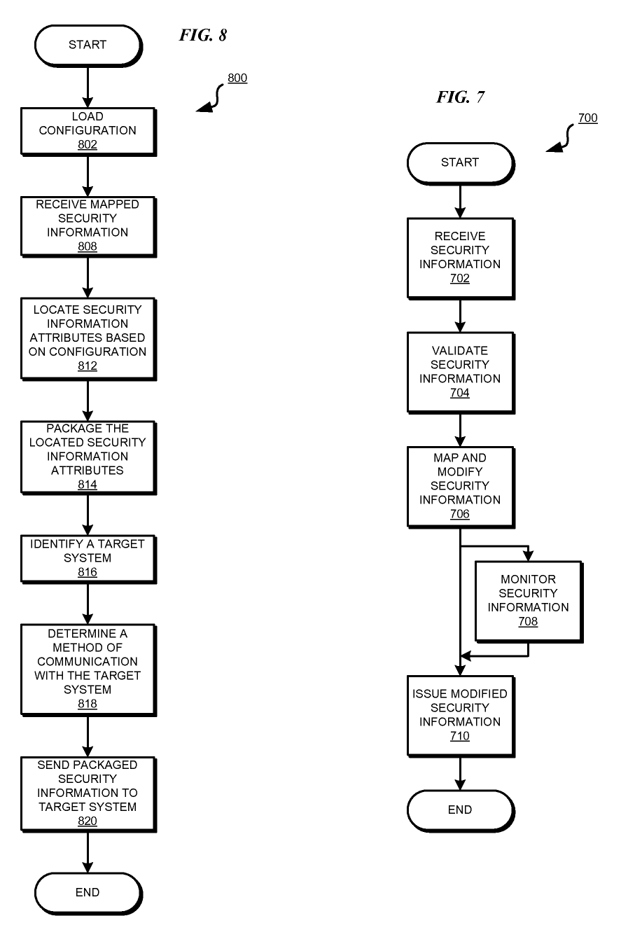

With reference to FIG. 7, this figure depicts a flowchart of a process of processing security information in a trust chain processing system in accordance with an illustrative embodiment. Process 700 may be implemented in trust chain processing system 602 in FIG. 6, and particularly in federated identity management system 604 in FIG. 6.

Process 700 begins by receiving security information, such as a SAML token associated with an incoming request (step 702). Process 700 validates the received security information (step 704). Process 700 maps or modifies the security information (step 706).

Process 700 may monitor the security information mapped in step 706 (step 708). Step 708 may occur while process 700 issues modified security information (step 710). Process 700 ends thereafter.

In one embodiment, steps 708 and 710 may occur simultaneously. In another embodiment, steps 708 and 710 may occur in temporal proximity of one another such that steps 708 and 710 process 700 performs within a predetermined time of one another. In another embodiment, step 708 may precede step 710.

With reference to FIG. 8, this figure depicts a flowchart of monitoring security information in accordance with an illustrative embodiment. Process 800 may be implemented in monitoring component 612 in FIG. 6. Process 800 may also be implemented as step 708 in FIG. 7.

Process 800 determines the monitoring functionality implemented within the trust chain. Process 800 is invoked and loads its local configuration (step 802). When invoked, process 800 receives the security and attribute information (step 808). Process 800 may receive the information in step 808 from previous components, such as the validation component, a mapping component, or other configurable trust chain processing component. For example, process 800 may receive such information from step 706 in FIG. 7 or optionally from step 704 in FIG. 7, if all required information were contained in the received token and no mapping were required.

Based on the local configuration information, Process 800 locates a set of the security information attributes, from the received information (step 812). Process 800 packages the located security information attributes (step 814). Process 800 identifies a target system (step 816). In one embodiment, step 816 may be performed before step 814 and packaging may be altered based on the target system identified. Furthermore, a target system may be identified, as in step 816, from the configuration loaded in step 802.

Target system identified in step 816 may be the target system that is to receive the packaged security information attributes of step 814. For example, target system identified in step 816 may be target system 650 in FIG. 6. As another example, target system identified in step 816 may be a reporting tool, a marketing system, a quality control log, or any other data processing system, application, or user.

Process 800 determines a method of communicating with the target system identified in step 816 (step 818). For example, process 800 may communicate with the target system using a web service request, a remote procedure call (RPC), an HTTP request, writing to a shared data storage location, or any other method suitable in a particular implementation.

Using the communication method identified in step 818, process 800 sends the packaged security information from step 814 (step 820). Process 800 ends thereafter.

The components in the block diagrams and the steps in the flowcharts described above are described only as exemplary. The components and the steps have been selected for the clarity of the description and are not limiting on the illustrative embodiments. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the illustrative embodiments.

Thus, a computer implemented method, apparatus, and computer program product are provided in the illustrative embodiments for propagating information from a trust chain processing. Security information, such as a SAML token, associated with an incoming request is validated, mapped, and monitored. Certain components of the security information are propagated to other systems, and modified security information is issued to a target system.

Processing security information, such as SAML token, is resource intensive in a data processing environment. Security information may be propagated to any data processing system, application, or user in a data processing environment in the manner of the illustrative embodiments, thus avoiding or reducing the cost of repeated processing of security information.

The invention can take the form of an entirely hardware embodiment, an entirely software embodiment, or an embodiment containing both hardware and software elements. In a preferred embodiment, the invention is implemented in software, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for propagating information in a trust chain processing, the method comprising:
receiving, upon a trust client invoking the trust chain processing, a mapped security information, the mapped security information being stored in one of a memory and a data storage associated with a data processing system;
locating a set of security information attributes from the mapped security information according to a configuration;
packaging the set of security information attributes to form a packaged security information; and
issuing the packaged security information to a target system, the target system being distinct from the trust client that invoked the trust chain processing, and wherein the locating, the packaging, and the issuing collectively form monitoring the trust chain processing.

2. The computer implemented method of claim 1 further comprising:
invoking a next component in the trust chain processing, wherein the invoking occurs one of (i) before the monitoring, (ii) after the monitoring, and (iii) during the monitoring.

3. The computer implemented method of claim 1, wherein the configuration identifies the set of security information attributes, the target system, and a method of communication with the target system, and wherein the configuration is identified in a trust chain configuration, the computer implemented method further comprising:
loading the configuration as a part of a dynamic configuration of the trust chain processing, wherein the loading the configuration makes the configuration available for monitoring the trust chain processing.

4. The computer implemented method of claim 3, wherein the configuration is one of stored in a configuration file, coded in a code, provided in a parameter list, specified in an input, and wherein the configuration identifies a plurality of target systems and a plurality of methods of communication to communicate with the plurality of target systems.

5. The computer implemented method of claim 3, wherein the configuration is one of stored in a configuration file, coded in a code, provided in a parameter list, specified in an input, and wherein the configuration identifies an organization of information in a monitoring log, the monitoring log being accessible to a plurality of target systems, a target system in the plurality of target systems using a subset of the information in the monitoring log.

6. The computer implemented method of claim 1, wherein the packaged security information is a JAAS subject.

7. The computer implemented method of claim 1, wherein the security information is a SAML token, and wherein the set of security information attributes is a set of SAML token attributes.

8. The computer implemented method of claim 1, wherein the packaged security information includes attributes that have been derived from a received security information.

9. The computer implemented method of claim 1 wherein the issuing in the monitoring and a second issuing to the trust client to the monitoring system and the trust chain processing occur simultaneously.

10. A computer usable program product comprising a computer usable medium including computer usable code for propagating information in a trust chain processing, the computer usable code comprising:
computer usable code for receiving, upon a trust client invoking the trust chain processing, a mapped security information, the mapped security information being stored in one of a memory and a data storage associated with a data processing system;
computer usable code for locating a set of security information attributes from the mapped security information according to a configuration;
computer usable code for packaging the set of security information attributes to form a packaged security information; and
computer usable code for issuing the packaged security information to a target system, the target system being distinct from the trust client that invoked the trust chain processing, and wherein the computer usable code for locating, the computer usable code for packaging, and the computer usable code for issuing collectively form computer usable code for monitoring the trust chain processing.

11. The computer usable program product of claim 10 further comprising:
computer usable code for invoking a next component in the trust chain processing, wherein the invoking occurs one of (i) before the monitoring, (ii) after the monitoring, and (iii) during the monitoring.

12. The computer usable program product of claim 10, wherein the configuration identifies the set of security information attributes, the target system, and a method of communication with the target system, and wherein the configuration is identified in a trust chain configuration, the computer usable program product further comprising:
computer usable code for loading the configuration as a part of a dynamic configuration of the trust chain processing, wherein executing the computer usable code for loading the configuration makes the configuration available for monitoring the trust chain processing.

13. The computer usable program product of claim 12, wherein the configuration is one of stored in a configuration file, coded in a code, provided in a parameter list, specified in an input, and wherein the configuration identifies a plurality of target systems and a plurality of methods of communication to communicate with the plurality of target systems.

14. The computer usable program product of claim 12, wherein the configuration is one of stored in a configuration file, coded in a code, provided in a parameter list, specified in an input, and wherein the configuration identifies an organization of information in a monitoring log, the monitoring log being accessible to a plurality of target systems, a target system in the plurality of target systems using a subset of the information in the monitoring log.

15. The computer usable program product of claim 10, wherein the packaged security information is a JAAS subject.

16. The computer usable program product of claim 10, wherein the security information is a SAML token, and wherein the set of security information attributes is a set of SAML token attributes.

17. The computer usable program product of claim 10, wherein the packaged security information includes attributes that have been derived from a received security information.

18. The computer usable program product of claim 10 wherein the issuing in the monitoring and a second issuing to the trust client to the monitoring system and the trust chain processing occur simultaneously.

19. A data processing system for propagating information in a trust chain processing, the data processing system comprising:
a storage device including a storage medium, wherein the storage device stores computer usable program code; and
a processor, wherein the processor executes the computer usable program code, and wherein the computer usable program code comprises:
computer usable code for receiving, upon a trust client invoking the trust chain processing, a mapped security information, the mapped security information being stored in one of a memory and a data storage associated with a data processing system;
computer usable code for locating a set of security information attributes from the mapped security information according to a configuration;
computer usable code for packaging the set of security information attributes to form a packaged security information; and
computer usable code for issuing the packaged security information to a target system, the target system being distinct from the trust client that invoked the trust chain processing, and wherein the computer usable code for locating, the computer usable code for packaging, and the computer usable code for issuing collectively form computer usable code for monitoring the trust chain processing.

20. The data processing system of claim 19 further comprising:
computer usable code for invoking a next component in the trust chain processing, wherein the invoking occurs one of (i) before the monitoring, (ii) after the monitoring, and (iii) during the monitoring.

21. The data processing system of claim 19, wherein the configuration identifies the set of security information attributes, the target system, and a method of communication with the target system, and wherein the configuration is identified in a trust chain configuration, the data processing system further comprising:
computer usable code for loading the configuration as a part of a dynamic configuration of the trust chain processing, wherein executing the computer usable code for loading the configuration makes the configuration available for monitoring the trust chain processing.

22. The data processing system of claim 21, wherein the configuration is one of stored in a configuration file, coded in a code, provided in a parameter list, specified in an input, and wherein the configuration identifies a plurality of target systems and a plurality of methods of communication to communicate with the plurality of target systems.

23. The data processing system of claim 21, wherein the configuration is one of stored in a configuration file, coded in a code, provided in a parameter list, specified in an input, and wherein the configuration identifies an organization of information in a monitoring log, the monitoring log being accessible to a plurality of target systems, a target system in the plurality of target systems using a subset of the information in the monitoring log.

24. The data processing system of claim 19, wherein the packaged security information is a JAAS subject.

25. The data processing system of claim 19, wherein the security information is a SAML token, and wherein the set of security information attributes is a set of SAML token attributes.

26. The data processing system of claim 19, wherein the packaged security information includes attributes that have been derived from a received security information.

27. The data processing system of claim 19 wherein the issuing in the monitoring and a second issuing to the trust client to the monitoring system and the trust chain processing occur simultaneously.
